(19) United States
(12) Patent Application Publication
(10) Pub. No.: US 2011/0237740 A1
(43) Pub. Date: Sep. 29, 2011

(54) BLEND OF SILYLATED POLYURETHANE CONTAINING POLYDIORGANOSILOXANE AND SILYLATED POLYURETHANE AND SUBSTRATES CONTAINING SAME AND PROCESS OF MAKING SAID SUBSTRATES

(75) Inventors: Narayana Padmanabha Iyer, Bangalore (IN); Anantharaman Dhanabalan, Bangalore (IN); Jos Delis, Bergen op Zoom (NL); Shayne Joseph Landon, Ballston Lake, NY (US); Remy Gauthier, Aire/Geneva (CH)

(73) Assignee: Momentive Performance Materials Inc., Albany, NY (US)

(21) Appl. No.: 12/748,773

(22) Filed: Mar. 29, 2010

(51) Int. Cl. C08L 75/04; B05D 3/10

(52) U.S. Cl. 524/590; 525/458; 427/387

(57) ABSTRACT

The present invention is directed to a composition having: (A) at least one silylated polyurethane resin containing polydiorganosiloxane; and, (B) at least one silylated polyurethane resin A.

### FIELD OF THE INVENTION

The present invention describes a blend composition comprising silylated polyurethane resin containing polydiorganosiloxane; and, silylated polyurethane. There is also provided a release coating comprising the same. In addition, there is provided a process of treating a substrate, and the substrate made therefrom.

### BACKGROUND OF THE INVENTION

The present invention relates to compositions, which are particularly suited for coating applications and are useful in the manufacture of paper and other articles having release characteristics. Release coatings are useful for many applications whenever it is necessary to provide a surface or material, which is relatively non-adherent to other materials, which would normally adhere thereto. Release paper compositions are widely used as coatings, which release pressure sensitive adhesives for labels, decorative laminates, transfer tapes as well as they are useful as non-stick surfaces for food handling and industrial packaging applications.

The release coating industry is based on rapidly coating a wide variety of substrates such as paper, polyester (PET), polyethylene (PE), polypropylene (PP), or polyethylene coated Kraft paper (PEK). The silicone coated substrate is either coated with a pressure sensitive adhesive followed by the desired label stock, or it is mated with an adhesive coated label stock such that the silicone coated substrate (siliconized liner) protects the adhesive layer until it reaches the desired application.

The most efficient process for preparing the silicone-coated substrate is by first coating the substrate with a very thin layer of a liquid silicone solution containing no solvent. The substrate is then heated to cause polymerization of the silicone solution to form a silicone polymer anchored to the substrate. The most efficient chemistry currently employed requires the platinum catalyzed hydrosilylation of a vinyl siloxane and hydridosiloxane, both containing two or more of their respective functional groups such that a crosslinked silicone polymer is produced. Apart from being catalyzed by costly platinum catalyst, these compositions are sensitive to addition of functional compounds, for example aminosilane based adhesion promoters, as such additives can poison the platinum catalyst and hence adversely affect the curing process.

### SUMMARY OF THE INVENTION

There is provided herein a composition comprising: (A) at least one silylated polyurethane resin containing polydiorganosiloxane; and, (B) at least one silylated polyurethane resin.

There is also provided herein a process of treating a substrate comprising:

coating a substrate with a composition comprising: (A) at least one silylated polyurethane resin containing polydiorganosiloxane; and, (B) at least one silylated polyurethane resin; and,

curing the coated substrate.

### DETAILED DESCRIPTION OF THE INVENTION

The inventors herein have unexpectedly found that a blend of silylated polyurethane resin containing polydiorganosiloxane, e.g., silylated polyurethane resin containing polydimethylsiloxane moieties; and, silylated polyurethane resin, provides a release coating composition that can cure through condensation, and which has desirable mechanical properties, while avoiding the aforementioned cost of platinum catalyst, and the sensitivity to other functional compounds. Further, apart from improving the mechanicals, the blend composition herein leads to “hydrophobic” silylated polyurethane resin compositions which are useful for making water repellant sealant compositions.

Even further, it has also been unexpectedly found that the aforementioned benefits are even more significant when the polydiorganosiloxane moieties of the silylated polyurethane resin containing polydiorganosiloxane contain up to about 25 polydiorganosiloxane units and/or when the blend contains a minor amount of silylated polyurethane resin containing polydiorganosiloxane, i.e., less than 50 weight percent of silylated polyurethane resin containing polydiorganosiloxane based on the total weight of the blended composition.

The composition described herein has advantageous use in release coating compositions for the use with labels and release liners, for example labels and release liners used in the paper industry, as well as use in sealant and adhesive compositions. The composition also has use as a water-repellant additive in various coatings such as sealants used in all aspects of commerce and industry, specifically in construction and construction materials, such as caulking sealant and coating material for sheets of metal, respectively.

It will be understood herein that all range end-points, e.g., weight percent range end-points recited herein, can be used interchangeably in any combination of such endpoints to construct further ranges than those which are expressly recited herein. Further such use will have no limitation on the use of a lower endpoint in one recited range being used as the upper endpoint in a newly constructed range, and likewise, the upper endpoint in one recited range being used as the lower endpoint in a newly constructed range. Further, all ranges recited herein may comprise all sub-ranges there between.

The silylated polyurethane resin containing polydiorganosiloxane (A) can comprise any silylated polyurethane resin that contains polydiorganosiloxane moieties. Polydiorganosiloxane moieties as used herein are understood to comprise at least one “D” silicone unit, i.e., a silicone unit of the general formula SiR₂O_{2/2} wherein each R is independently an alkyl of from 1 to about 18 carbon atoms, preferably from 1 to about 6 carbon atoms, e.g., methyl, ethyl, propyl, isopropyl, most preferably methyl; alkenyl of from 2 to about 18 carbon atoms, more preferably 2 to about 6 carbon atoms; and, aryl of from 6 to about 18 carbon atoms, preferably from 6 to about 12 carbon atoms.

In one embodiment herein the polydiorganosiloxane moiety of at least one silylated polyurethane resin containing polydiorganosiloxane (A) is polydimethylsiloxane.

In one specific embodiment herein, silylated polyurethane resin containing polydiorganosiloxane (A) is made by the process comprising reacting a hydroxyl- or isocyanate-terminated polyurethane prepolymer based on polydiorganosiloxane with a isocyanato silane, or an active hydrogen-containing silane, respectively. The silylated polyurethane resin containing polydiorganosiloxane may comprise at least 3 urethane moieties therein.

The hydroxyl- or isocyanate-terminated polyurethane prepolymer based on polydiorganosiloxane can be made by chain extension of carbinol-terminated polydiorganosiloxane with diisocyanate. Depending on the ratio of isocyanate to hydroxyl groups, (NCO/OH)>1 or <1, a pre-polymer either with isocyanato or hydroxyl group termination, respectively can be obtained. The reaction can be performed neat, without a need to use any solvent, although solvent, e.g., aliphatic solvent, such as for example, toluene, can be used. In addition, the chain extension of carbinol-terminated polydiorganosiloxane with diisocyanate can be conducted in the presence of a catalyst, such as those catalysts described herein below, e.g., a condensation catalyst.

The carbinol-terminated polydiorganosiloxane herein can comprise from about one of the D silicone units as described above up to about 25 D silicone units, more preferably up to about 12 silicone D units, even more preferably up to about 8 silicone D units and most preferably about 5 silicone D units. In one embodiment herein the carbinol-terminated polydiorganosiloxane herein can comprise greater than about 25 D silicone units as described above, and in one other embodiment from 25 to 100 D silicone units.

The carbinol-terminated polydiorganosiloxane used to make the hydroxyl- or isocyanate-terminated polyurethane prepolymer based on polydiorganosiloxane comprises, in addition to the D silicone unit(s), at least one additional silicone M unit (preferably at, least two silicone M units) of the general formulae SiR*₃O_{1/2}, wherein each R* is independently R or a hydroxyl-terminated divalent alkylene group of from 2 to about 10 carbon atoms, preferably from 2 to about 6 carbon atoms, optionally containing etheric oxygen, provided that at least one R* of the M unit(s) is a hydroxyl terminated divalent alkylene group of from 2 to about 10 carbon atoms, optionally containing etheric oxygen.

In addition, carbinol-terminated polydiorganosiloxane used to make the hydroxyl- or isocyanate-terminated polyurethane prepolymer based on polydiorganosiloxane can contain any one or more of D*, T or Q silicone unit(s), i.e., SiR*₂O_{2/2}, SiR*O_{3/2}, or SiO_{4/2} respectively, wherein each R* is independently R or a hydroxyl-terminated divalent alkylene group of from 2 to about 10 carbon atoms, optionally containing etheric oxygen.

In one embodiment herein the carbinol-terminated polydiorganosiloxane is an M silicone unit-terminated linear molecule wherein the M silicone units both contain a hydroxyl-terminated divalent alkylene group of from 2 to about 10 carbon atoms, optionally containing etheric oxygen.

In one specific embodiment the carbinol-terminated polydiorganosiloxane can be of the general formula (I):

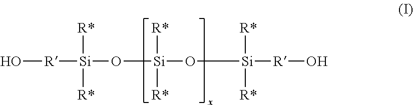

wherein R* is as defined and R′ is divalent alkylene group of from 2 to about 10 carbon atoms, optionally containing etheric oxygen. Preferably R′ is a divalent alkylene group of from 2 to about 6 carbon atoms, optionally containing etheric oxygen. In one embodiment R′ is —(CH₂)₂— or —(CH₂)₂—O—(CH₂)₃—.

The diisocyanate which is used to make the hydroxyl- or isocyanate-terminated polyurethane prepolymer based on polydiorganosiloxane can comprise any of the polyisocyanates, e.g., diisocyanates described herein below. Some specific examples of suitable diisocyanates are Isophorone diisocyanate (IPDI), toluene diisocyanate (TOO, hexamethylene diisocyanate (HDI), and combinations thereof.

In addition the diisocyanate described herein can comprise any of the diisocyanates described in EP 1506266B1; U.S. Pat. No. 6,545,104; and, U.S. Pat. No. 5,908,808, the entire contents of each which are incorporated herein in their entirety.

The isocyanato silane which is reacted with hydroxyl terminated polyurethane prepolymer based on polyorganosiloxane in order to prepare the SPUR based on polydiorganosiloxane (A) can be any of the isocyanatosilanes known to those skilled in the art and those known in the art of polyurethane chemistry. More specifically, the isocyanato silane can be any of those which are described herein below.

Alternatively, the active hydrogen-containing silane which is reacted with isocyanate-terminated polyurethane prepolymer based on polyorganosiloxane in order to prepare the SPUR based on polydiorganosiloxane (A) can be any of the active hydrogen containing silanes known to those skilled in the art and those known in the art of polyurethane chemistry. Some suitable examples of active hydrogen-containing silane are the below described silylation reactants for reaction with the isocyanate-terminated PUR prepolymers which must contain functionality that is reactive with isocyanate and at least one readily hydrolyzable and subsequently crosslinkable group. Some suitable examples are aminopropyltrimethoxy silane, aminopropyltriethoxy silane, aminoethylaminopropyldimethoxy silane, and combinations thereof.

In another embodiment herein the silylated polyurethane resin containing polydiorganosiloxane (A) is made by the reactions shown in Scheme 1 below.

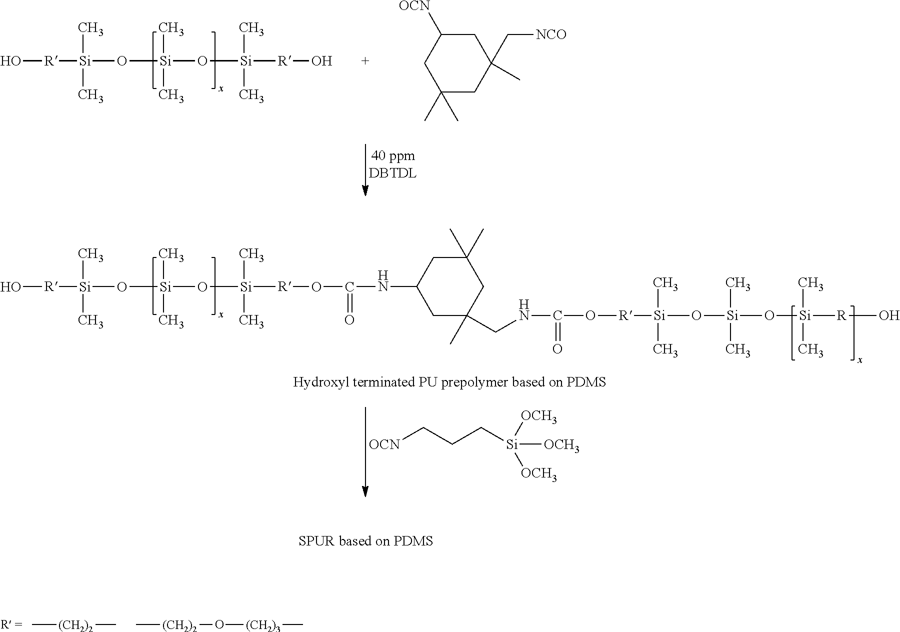

As shown in Scheme-1, the carbinol terminated short-chain polydimethylsiloxanes were reacted with diisocyanates to form OH-end terminated polyurethanes which in turn can be reacted with isocyanato silane to form moisture curable end-silylated polyurethane. Carbinol terminated short-chain polydimethylsiloxanes with varying chain-lengths can be used in these reactions. Though the specific examples cited in scheme 1 pertain to carbinol terminated short-chain polydimethylsiloxanes, i.e., with a D-unit silicone chain length (i.e., value of x) of 5, 12, 18 and 25, the scheme described herein is applicable to carbinol terminated short-chain polydimethylsilxoanes with lower/higher/intermediate D-unit silicone chain lengths (i.e. values of X) as well.

The hydroxyl terminated polyurethane prepolymer in Scheme 1 was reacted with isocyanatopropyltrimethoxysilane using DBTDL as a catalyst, although any catalyst can be used, such as those condensation catalysts described herein. The reaction can be performed both with and without solvent. Typically, in a neat reaction, equimolar amounts of hydroxyl terminated polyurethane made from carbinol terminated polydimethylsiloxane and isocyanatopropyltrimethoxysilane can be used. When desired, some suitable non-limiting examples of solvents that can be used include toluene, xylene, and combinations thereof.

The silylated polyurethane resin (SPUR) component (B) used herein can be moisture curable silylated polyurethane resin and is a known material, and in general, can be obtained by (a) reacting an isocyanate-terminated polyurethane (PUR) prepolymer with a suitable silane, e.g., one possessing both hydrolyzable functionality, specifically, one to three alkoxy groups for each silicon atom, and active hydrogen functionality, e.g., mercapto, primary amine and, advantageously, secondary amine, which is reactive for isocyanate, or by (b) reacting a hydroxyl-terminated PUR prepolymer with a suitable isocyanate-terminated silane, e.g., one possessing one to three alkoxy groups. The details of these reactions, and those for preparing the isocyanate-terminated and hydroxyl-terminated PUR prepolymers employed therein can be found in, amongst others: U.S. Pat. Nos. 4,985,491, 5,919,888, 6,197,912, 6,207,794, 6,303,731, 6,359,101 and 6,515,164 and published U.S. Patent Application Nos. 2004/0122253 and 2005/0020706 (isocyanate-terminated PUR prepolymers); U.S. Pat. Nos. 3,786,081 and 4,481,367 (hydroxyl-terminated PUR prepolymers); U.S. Pat. Nos. 3,627,722, 3,632,557, 3,971,751, 5,623,044, 5,852,137, 6,197,912, 6,207,783 and 6,310,170 (moisture-curable SPUR resin obtained from reaction of isocyanate-terminated PUR prepolymer and reactive silane, e.g., aminoalkoxysilane); and, U.S. Pat. Nos. 4,345,053, 4,625,012, 6,833,423 and published U.S. Patent Application 2002/0198352 (moisture-curable SPUR resin obtained from reaction of hydroxyl-terminated PUR prepolymer and isocyanatosilane). The entire contents of the foregoing U.S. patent documents are each incorporated by reference herein in their entireties.

### (a) Moisture-curable SPUR Resin Obtained From Isocyanate-terminated PUR Prepolymer

In one embodiment herein the moisture-curable SPUR resin can be any of the SPURs described in U.S. Pat. No. 5,990,257 and can be made by any of the methods described therein, the entire contents of which are incorporated herein by reference in their entirety.

The isocyanate-terminated PUR prepolymers are obtained by reacting one or more polyols, advantageously, diols, with one or more polyisocyanates, advantageously, diisocyanates, in such proportions that the resulting prepolymers will be terminated with isocyanate. In the case of reacting a diol with a diisocyanate, a molar excess of diisocyanate will be employed.

Included among the polyols that can be utilized for the preparation of the isocyanate-terminated PUR prepolymer are polyether polyols, polyester polyols such as the hydroxyl-terminated polycaprolactones, polyetherester polyols such as those obtained from the reaction of polyether polyol with e-caprolactone, polyesterether polyols such as those obtained from the reaction of hydroxyl-terminated polycaprolactones with one or more alkylene oxides such as ethylene oxide and propylene oxide, hydroxyl-terminated polybutadienes, and the like.

Specific suitable polyols that can be utilized for the preparation of the isocyanate-terminated PUR prepolymer include the poly(oxyalkylene)ether diols (i.e., polyether diols), in particular, the poly(oxyethylene)ether diols, the poly(oxypropylene)ether diols and the poly(oxyethylene-oxypropylene)ether diols, poly(oxyalkylene)ether triols, poly(tetramethylene)ether glycols, polyacetals, polyhydroxy polyacrylates, polyhydroxy polyester amides, polyhydroxy polythioethers, polycaprolactone diols and triols, and the like. In one embodiment of the present invention, the polyols used in the production of the isocyanate-terminated PUR prepolymers are poly(oxyethylene)ether diols with equivalent weights between about 500 and 25,000. In another embodiment of the present invention, the polyols used in the production of the isocyanate-terminated PUR prepolymers are poly(oxypropylene)ether diols with equivalent weights between about 1,000 to 20,000. Mixtures of polyols of various structures, molecular weights and/or functionalities can also be used.

In one specific embodiment herein silylated polyurethane resin (B) is made from high molecular weight polypropylene glycols, e.g., polypropylene glycols having a molecular weight of from about 300 to about 30,000, preferably from about 1,000 to about 20,000 and most preferably from about 2,000 to about 16,000. The silylated polyurethane resin containing poldiorganosiloxane (A) can also be blended with silylated polyurethane resin (B) made from high Mw polypropylene glycols (for example, Acclaim-8000 or Acclaim-12000 procured from Bayers) which results in an improvement of the mechanical properties of the composition as compared to pure component (B) in the absence of any component (A).

The polyether polyols can have a functionality up to about 8 but advantageously have a functionality of from 2 to 4 and more advantageously, a functionality of 2 (i.e., diols). Especially suitable are the polyether polyols prepared in the presence of double-metal cyanide (DMC) catalysts, an alkaline metal hydroxide catalyst, or an alkaline metal alkoxide catalyst; see, for example, U.S. Pat. Nos. 3,829,505, 3,941,849, 4,242,490, 4,335,188, 4,687,851, 4,985,491, 5,096,993, 5,100,997, 5,106,874, 5,116,931, 5,136,010, 5,185,420 and 5,266,681, the entire contents of each of the foregoing patents are incorporated herein by reference in their entireties. Polyether polyols produced in the presence of such catalysts tend to have high molecular weights and low levels of unsaturation, properties of which, it is believed, are responsible for the improved performance of inventive retroreflective articles. The polyether polyols preferably have a number average molecular weight of from about 1,000 to about 25,000, more preferably from about 2,000 to about 20,000, and even more preferably from about 4,000 to about 18,000. Examples of commercially available diols that are suitable for making the isocyanate-terminated PUR prepolymer include ARCOL R-1819 (number average molecular weight of 8,000), E-2204 (number average molecular weight of 4,000), and ARCOL E-2211 (number average molecular weight of 11,000).

Any of numerous polyisocyanates, advantageously, diisocyanates, and mixtures thereof, can be used to provide the isocyanate-terminated PUR prepolymers.

In one embodiment, the polyisocyanate can be diphenylmethane diisocyanate (“MDI”), polymethylene polyphenylisocyanate (“PMDI”), paraphenylene diisocyanate, naphthylene diisocyanate, liquid carbodiimide-modified MDI and derivatives thereof, isophorone diisocyanate, dicyclohexylmethane-4,4′-diisocyanate, toluene diisocyanate (“TDI”), particularly the 2,6-TDI isomer, as well as various other aliphatic and aromatic polyisocyanates that are well-established in the art, and combinations thereof.

Silylation reactants for reaction with the isocyanate-terminated PUR prepolymers described above must contain functionality that is reactive with isocyanate and at least one readily hydrolyzable and subsequently crosslinkable group (active hydrogen-containing silane), e.g., alkoxy. Particularly useful silylation reactants are the silanes of the general formula:

X—R¹—Si(R²)ₓ(OR³)₃₋ₓ

wherein X is an active hydrogen-containing group that is reactive for isocyanate, e.g., —SH or —NHR⁴ in which R⁴ is H, a monovalent hydrocarbon group of up to 8 carbon atoms or —R⁵—Si(R⁵)_{y}(OR⁷)_{3-y}, R¹ and R⁵ each is the same or different divalent hydrocarbon group of up to 12 carbon atoms, optionally containing one or more heteroatoms, each R² and R⁶ is the same or different monovalent hydrocarbon group of up to 8 carbon atoms, each R³ and R⁷ is the same or different alkyl group of up to 6 carbon atoms and x and y each, independently, is 0, 1 or 2.

Specific silanes for use herein include the mercaptosilanes 2-mercaptoethyl trimethoxysilane, 3-mercaptopropyl trimethoxysilane, 2-mercaptopropyl triethoxysilane, 3-mercaptopropyl triethoxysilane, 2-mercaptoethyl tripropoxysilane, 2-mercaptoethyl tri sec-butoxysilane, 3-mercaptopropyl tri-t-butoxysilane, 3-mercaptopropyl triisopropoxysilane, 3-mercaptopropyl trioctoxysilane, 2-mercaptoethyl tri-2′-ethylhexoxysilane, 2-mercaptoethyl dimethoxy ethoxysilane, 3-mercaptopropyl methoxyethoxypropoxysilane, 3-mercaptopropyl dimethoxy methylsilane, 3-mercaptopropyl methoxy dimethylsilane, 3-mercaptopropyl ethoxy dimethylsilane, 3-mercaptopropyl diethoxy methylsilane, 3-mercaptopropyl cyclohexoxy dimethyl silane, 4-mercaptobutyl trimethoxysilane, 3-mercapto-3-methylpropyltrimethoxysilane, 3-mercapto-3-methylpropyl-tripropoxysilane, 3-mercapto-3-ethylpropyl-dimethoxy methylsilane, 3-mercapto-2-methylpropyl trimethoxysilane, 3-mercapto-2-methylpropyl dimethoxyphenylsilane, 3-mercaptocyclohexyl-trimethoxysilane, 12-mercaptododecyl trimethoxy silane, 12-mercaptododecyl triethoxy silane, 18-mercaptooctadecyl trimethoxysilane, 18-mercaptooctadecyl methoxydimethylsilane, 2-mercapto-2-methylethyl-tripropoxysilane, 2-mercapto-2-methylethyl-trioctoxysilane, 2-mercaptophenyl trimethoxysilane, 2-mercaptophenyl triethoxysilane, 2-mercaptotolyl trimethoxysilane, 2-mercaptotolyl triethoxysilane, 1-mercaptomethyltolyl trimethoxysilane, 1-mercaptomethyltolyltriethoxysilane, 2-mercaptoethylphenyl trimethoxysilane, 2-mercaptoethylphenyl triethoxysilane, 2-mercaptoethyltolyl trimethoxysilane, 2-mercaptoethyltolyl triethoxysilane, 3-mercaptopropylphenyl trimethoxysilane and, 3-mercaptopropylphenyl triethoxysilane, and the aminosilanes 3-aminopropyltrimethoxysilane, 3-aminopropyltriethoxysilane, 4-aminobutyltriethoxysilane, N-methyl-3-amino-2-methylpropyltrimethoxysilane, N-ethyl-3-amino-2-methylpropyltrimethoxysilane, N-ethyl-3-amino-2-methylpropyldiethoxymethylsilane, N-ethyl-3-amino-2-methylpropyltriethoxysilane, N-ethyl-3-amino-2-methylpropylmethyldimethoxysilane, N-butyl-3-amino-2-methylpropyltrimethoxysilane, 3-(N-methyl-2-amino-1-methyl-1-ethoxy)-propyltrimethoxysilane, N-ethyl-4-amino-3,3-dimethyl-butyldimethoxymethylsilane, N-ethyl-4-amino-3,3-dimethyl butyltrimethoxy-silane, N-(cyclohexyl)-3-aminopropyltrimethoxysilane, N-(2-aminoethyl)-3-aminopropyltrimethoxysilane, N-(2-aminoethyl)-3-aminopropyltriethoxy-silane, N-(2-aminoethyl)-3-aminopropylmethyldimethoxysilane, aminopropyltriethoxysilane, bis-(3-trimethoxysilyl-2-methylpropyl)amine and N-(3′-trimethoxysilylpropyl)-3-amino-2-methylpropyltrimethoxysilane.

A catalyst will ordinarily be used in the preparation of the isocyanate-terminated PUR prepolymers. Advantageously, condensation catalysts are employed since these will also catalyze the cure (hydrolysis followed by crosslinking) of the silylated polyurethane resin containing polydiorganosiloxane (A) and SPUR resin component (B) of the invention. Suitable condensation catalysts include the dialkyltin dicarboxylates such as dibutyltin dilaurate and dibutyltin acetate, tertiary amines, the stannous salts of carboxylic acids, such as stannous octoate and stannous acetate, and the like. In one embodiment of the present invention, dibutyltin dilaurate catalyst is used in the production of the PUR prepolymer. Other useful catalysts include zirconium-containing and bismuth-containing complexes such as KAT XC6212, K-KAT XC-A209 and K-KAT 348, supplied by King Industries, Inc., aluminum/titanium chelates such as the TYZER® types, available from DuPont company, and the KR types, available from Kenrich Petrochemical, Inc., and other organometallic catalysts, e.g., those containing a metal such as Zn, Co, Ni, Fe, and the like.

### (b) Moisture-curable SPUR Resins Obtained From Hydroxyl-terminated PUR Prepolymers.

The moisture-curable SPUR resin (B) of the invention can, as previously indicated, be prepared by reacting a hydroxyl-terminated PUR prepolymer with an isocyanatosilane. The hydroxyl-terminated PUR prepolymer can be obtained in substantially the same manner employing substantially the same materials, i.e., polyols, polyisocyanates and optional catalysts (preferably condensation catalysts), described above for the preparation of isocyanate-terminated PUR prepolymers the one major difference being that the proportions of polyol and polyisocyanate will be such as to result in hydroxyl-termination in the resulting prepolymer. Thus, e.g., in the case of a diol and a diisocyanate, a molar excess of the former will be used thereby resulting in hydroxyl-terminated PUR prepolymer.

Useful silylation reactants for the hydroxyl-terminated SPUR resins are those containing isocyanate termination and readily hydrolyzable functionality, e.g., 1 to 3 alkoxy groups. Suitable silylating reactants are the isocyanatosilanes of the general formula:

OCN—R⁸—Si(R⁹)_{y}(OR¹⁰)_{3-y}

wherein R⁸ is an alkylene group of up to 12 carbon atoms, optionally containing one or more heteroatoms, each R⁹ is the same or different alkyl or aryl group of up to 8 carbon atoms, each R¹⁰ is the same or different alkyl group of up to 6 carbon atoms and y is 0, 1 or 2. In one embodiment, R⁶ possesses 1 to 4 carbon atoms, each R¹⁹ is the same or different methyl, ethyl, propyl or isopropyl group and y is 0.

Specific isocyanatosilanes that can be used herein to react with the foregoing hydroxyl-terminated PUR prepolymers to provide moisture-curable SPUR resins include isocyanatopropyltrimethoxysilane, isocyanatoisopropyl trimethoxysilane, isocyanato-n-butyltrimethoxysilane, isocyanato-t-butyltrimethoxysilane, isocyanatopropyltriethoxysilane, isocyanatoisopropyltriethoxysilane, isocyanato-n-butyltriethoxysilane, isocyanato-t-butyltriethoxysilane, and the like.

In one embodiment herein the silylated polyurethane resin (B) has a viscosity of from 1 to about 3,000 cP, preferably from 1 to about 2,000 cP measured at 25 degrees Celsius.

The composition herein in one embodiment can be cured by known means and can be moisture-curable and/or photo-curable. The composition herein in one other embodiment is capable of condensation cure. In presence of moisture, the material herein undergoes condensation, i.e., it undergoes hydrolysis that results in the formation of silanol followed by condensation of the silanol to form siloxanes.

In one non-limiting embodiment herein, components (A) and/or (B) can be in the absence of urea moieties.

In another embodiment herein, the silylated polyurethane resin containing polydiorganosiloxane (A) can be present in an amount of from about 5 weight percent to about 30 weight percent; and, silylated polyurethane resin (B) can be present in an amount of from about 70 weight percent to about 95 weight percent, said weight percent being based on the total weight of components (A) and (B).

In another embodiment herein, the silylated polyurethane resin containing polydiorganosiloxane (A) can be present in an amount of from about 5 weight percent to about 25 weight percent; and, silylated polyurethane resin (B) can be present in an amount of from about 75 weight percent to about 95 weight percent, said weight percent being based on the total weight of components (A) and (B).

In yet another embodiment herein, the silylated polyurethane resin containing polydiorganosiloxane (A) can be present in an amount of from about 5 weight percent to about 20 weight percent; and, silylated polyurethane resin (B) can be present in an amount of from about 80 weight percent to about 95 weight percent, said weight percent being based on the total weight of components (A) and (B).

There is also provided herein a release coating comprising the composition described herein. The release coating can include other known additives such as the non-limiting examples of filler, adhesion promoter, crosslinker, plasticizer, pigment, initiator, and the like.

The composition herein (as well as the release coating herein) can be cured by any means as discussed above.

The substrate which can be treated herein can comprise any commercially and/or technically known substrate, such as metal, wood, plastic, paper, textile and the like. More preferably herein the substrates are paper, polyester (PET) (such as those described in U.S. Pat. No. 6,716,533; and, U.S. Pat. No. 7,090,923 the contents of each of which are incorporated herein by reference in their entirety), polyethylene (PE) (such as those described in WO2009088474; WO2009088472 the contents of each of which are incorporated herein by reference in their entirety), polypropylene (PP), polyethylene coated Kraft paper (PEK), and combinations thereof.

Means of coating the substrate can be done by any known or commercially advantageous means that coats the substrate to the desired degree such as rolling, dip-coating, spraying, epitaxial deposition, and the like. In one embodiment, only one surface of a substrate can be coated, or alternatively, all surfaces of the substrate can be coated. The substrate can have been previously pre-treated by for example corona treatment, or other material like a primer prior to coating with the composition described herein (or the release coating composition described herein). The coated substrate can subsequently have a label placed on top.

Typical application methods used in the industry to coat above mentioned substrates are size press applications, gravure rollers using direct and off-set methods, mayer-bar and multi-roll application methods. The latter usually comprise heads composed of a series of rolls that are placed next to one another, including in particular a pressure roll and a coating roll that are continuously fed with the curable composition. Typical products produced by these processes are baking paper, release papers for adhesives in the label industry, for tape applications and graphic arts. Other examples can be found in hygiene applications and construction market like for bitumen release films.

The substrate made by the process herein can have at least one advantageous property as compared to a substrate made in an equivalent manner but in the absence of the silylated polyurethane resin containing polydiorganosiloxane (A), such as one or more of the non-limiting examples of improved tensile strength, modulus, elongation at break, Shore-A hardness and water repellency (i.e. hydrophobicity).

The composition herein can have a Shore A hardness from about 10 to 80 Shore A, more preferably from 20 to 70 Shore A, most preferably from 30 to 60 Shore A as determined by means of a Durometer (Shore hardness, ISO 868). The currently used solvent free addition cured release coatings normally have Shore A values higher than that leading to coatings with a high coefficient of friction. The coefficient of friction of the formulations of the current invention are in the range of release coatings coated out of solvent which is beneficial for applications in for example the thermal transfer ribbon market. The composition herein can have a coefficient of friction from 0.05 to 1.0, more preferably from 0.07 to 0.8, most preferably from 0.1 to 0.6 measured by ASTM method (ASTM D 1894-87).

As stated above, there is also provided herein a sealant composition comprising the composition described herein. The sealant composition can in one non-limiting embodiment be a construction sealant, e.g., caulking sealant. The sealant composition can contains other known components in such sealants, which are known to those skilled in the art and will not be discussed herein. The release coating and/or sealant compositions described herein can be one-part or two part compositions. In a two-part composition the components therein can be separated prior to the desired reaction time in any manner that will prevent an undesirable premature cure. Advantageously, the separated two-part composition can have one or both of the two parts stored in the absence of moisture, preferably in the absence of atmospheric moisture. Means of separation and desirable separation scenario(s) of components in the two respective parts are well known to those skilled in the art and will not be discussed herein but can be such as those described in US2007/0129528 A1 the entire contents of which are incorporated herein by reference.

The release coating herein can be made by any method, but generally will involve the blending of components (A) and (B) in a conventional manner, e.g., in a mixer, a blender, an extruder and the like.

### EXAMPLES

### Synthesis of Polyurethane Prepolymer from Carbinol-Terminated Polydimethylsiloxanes

Reference is made herein to Scheme 1 described above. Hydroxyl terminated or NCO terminated polyurethane pre-polymers were synthesized by chain extension of carbinol terminated polydimethylsiloxane with diisocyanate. Depending on the ratio of NCO/OH, >1 or <1, a pre-polymer either with isocyanato or hydroxyl group termination can be obtained. In Scheme 1 above a hydroxyl-terminated polyurethane pre-polymer was obtained. The reaction was performed neat, without any solvent. The calculated amount of diisocyanate (Isophoronediisocyanate, IPDI) was added to carbinol terminated polydimethylsiloxane taken in a 3-necked RB flask. The contents were mixed thoroughly and the catalytic amount of DBTDL dibutyltindilaurate catalyst (10-50 ppm) was added to the above mixture at room temperature. Subsequently, the reaction mixture was stirred and heated to 80-85 deg C. and kept at that temperature for 2 hours (hr). The progress of the reaction was monitored by FTIR spectra for the disappearance of the NCO peak. At the completion of the reaction after 2 hr, the reaction mixture was cooled to room temperature and a viscous liquid product was obtained. These formulations are described in Tables 1 and 2 below.

TABLE 1
Synthesis of PU prepolymer

| | weight of reactants | | |
|---|---|---|---|
| PU | Carbinol | Isophorone | |
| prepolymer | terminated | diisocyanate | DBTDL |
| Code | PDMS (g) | (g) | (g) |
| PU-PDMS-1 | 50 | 9.28 | 0.032 |
| PU-PDMS-2 | 50 | 4.94 | 0.032 |
| PU-PDMS-3 | 50 | 2.97 | 0.032 |
| PU-PDMS-4 | 50 | 2.62 | 0.032 |

TABLE 2

| | |
|---|---|
| PU | GPC analysis |

| prepolymer | molecular | |
|---|---|---|
| code | weight (Mn) | PDI |
| PU-PDMS-1 | 2872 | 1.4 |
| PU-PDMS-2 | 3510 | 1.43 |
| PU-PDMS-3 | 4566 | 1.535 |
| PU-PDMS-4 | 9782 | 1.66 |

### Synthesis of Silylated Polyurethane Based on Carbinol-Terminated Polydimethylsiloxane

TABLE 3

| | weight of reactants | | | |
|---|---|---|---|---|
| | | Isocyanato- | | |
| SPUR based | PU | propyl- | | Viscosity |
| on PDMS | prepolymer | trimethoxy- | DBTDL | of SPUR |
| Code | (g) | silane (g) | (g) | (cP) |
| SPUR-PDMS-1 | 50 | 14.44 | 0.03 | 1515 |
| SPUR-PDMS-2 | 50 | 8.31 | 0.03 | 505 |
| SPUR-PDMS-3 | 50 | 5.18 | 0.03 | 1135 |
| SPUR-PDMS-4 | 50 | 4.58 | 0.03 | 1976 |

Each of the hydroxyl terminated PU prepolymers prepared above were reacted with isocyanatopropyltrimethoxysilane using DBTDL as a catalyst. Equimolar amounts of each of the hydroxyl terminated polyurethane made from carbinol terminated PDMS and isocyanatopropyltrimethoxysilane were taken in a round bottom flask iuy. To above mixture, catalytic amounts of DBTDL catalyst (10-50 ppm) were added and the reaction mixture was heated to 80-85 deg C. with stirring. The reaction was monitored by FTIR spectra, for the disappearance of —NCO peak. Upon the completion of the reaction (2-5 hr), the reaction mixture was cooled to room temperature. All reactions were conducted in the absence of solvent.

Both the polyurethane prepolymers made from carbinol terminated polydimethylsiloxane identified above in Tables 1 and 2, and their silylated versions in Table 3, were obtained as viscous liquids. The polymer chain growth of polycondensation reactions of carbinol terminated polydimethylsiloxane with diisocyanate, and the subsequent silylated polyurethane prepolymer were identified through GPC and NMR analysis which is shown below.

The contact angle data and release force measurements performed with SPUR PDMS1-SPUR PDMS 4 (as shown below in Tables 4 and 5) are indicative of dependence of the above properties on the D silicone unit chain length of PDMS carbinol: The higher the D silicone unit chain length, the more hydrophobic the surface is and as a result the lower the release force is, as is evident from the below tables 4 and 5.

TABLE 4

| | D-chain length of | Average contact angle |
|---|---|---|
| Material | PDMS Carbinol | (Std. Dev.) |
| SPUR PDMS 1 | 5 | 98.37 (0.8) |
| SPUR PDMS 2 | 12 | 102.57 (1.2) |
| SPUR PDMS 3 | 18 | 104.84 (1.1) |
| SPUR PDMS 4 | 25 | 107.7 (0.6) |
| SL6161 | | 108.28 (1.26) |

TABLE 5

| | | Average release force (cN/Inch) | | | |
|---|---|---|---|---|---|
| | D-chain | Set-1 (T7475) | | Set-2 (T7476) | |
| | length of | after | after | after | after |
| Material | PDMS Carbinol | 1 day | 7 day | 1 day | 7 day |
| SPUR PDMS-1 | 5 | 582 | 785 | 1019 | 1250 |
| SPUR-PDMS-2 | 12 | 90.1 | 120 | 148 | 210 |
| SPUR PDMS-3 | 18 | 38.3 | 42.3 | 61.7 | 73.8 |
| SPUR PDMS-4 | 25 | 42.1 | 37.5 | 79 | 69.2 |
| SL6161 | | 7.7 | 10 | 54 | 55 |

See below for definition of SL6161

Procedure for making Release Coatings

A thoroughly mixed mixture of 50 grams of each SPUR PDMS in Table 5 and condensation cure catalyst (DBTDL, 0.25 g, 0.5%) was coated onto a PET film, by drawing down the mixture uniformly with the aid of a knife. The resulting coating was subsequently cured for 60 sec at 120° C. and post cured at room temperature for at least 8 h. The coating weight was determined by XRF method described by FINAT (Test method number 7: Energy-Dispersive X-Ray Fluorescence Spectroscopy, described in FINAT Technical Handbook of Test Methods) and it was maintained at 1.5 g per square meter.

Upon complete curing of the coating, the standard test tapes Tesa 7475 and Tesa 7476 were applied on the coating and aged at room temperature under a weight of 70 g per square cm. The force necessary to release the tape was measured at an angle of 180° in cN/inch, after 1 and 7 days and reported.

### Preparation of the Reference Formulation (SL 6161)

100 parts per weight of a vinyl end-stopped polydimethylsiloxane (250 mPa·s at 25° C., vinyl content=0.22 mmol/g and the general formula M^{vi}₂-D₁₂₀), 5.5 parts of a polymethylhydrogensiloxane (30 mPa·s at 25° C., the general formula Me₃SiO(Me₂SiO)₁₅(MeHSiO)₃₀SiMe₃, with molar SiH/SiVi ratio of 2.5, where Me is methyl and H is hydrogen), 0.4 parts of an inhibitor (diallyl maleate) and a Pe-complex having vinylsiloxane ligands (Pt-Karstedt catalyst, 100 ppm of platinum) were mixed together at 25° C. The resulting mixture was coated onto PET film, as described above, and cured for 30 sec at 120° C. The coat weight was maintained at 1.5 grams per square meter. Test tapes were applied onto the coating and the measurement of release force was done as described above.

A given weight percent ratio (as indicated in Tables 6 and 7 below) of PDMS based SPUR (component (A)) was blended with SPUR (B) made from high Mw polypropylene glycol, along with a moisture cure catalyst such as dibutyltin dilaurate (DBTDL) (˜0.5%) in a high speed mixer, i.e., a Hauschild mixer. The flowable blend thus obtained was poured onto a Teflon mold and moisture cured for a week to get a sheet of ˜3 mm thick. The mechanical properties (such as tensile strength, modulus, elongation at break and hardness (Shore-A) of the blends containing different proportions of PDMS based SPUR (component (A)) (5-20 wt %) were measured and compared with neat SPUR (component (B)) made from high Mw polypropylene glycols. Similar blends were made with PDMS based SPUR (component (A)) made from PDMS carbinols with different D silicone unit chain lengths (i.e., 5, 12, 18 and 25 D silicone units). As shown in the tables 6 and 7 below, the compatibility of component (A) with SPUR (B) made from high Mw polypropylene glycol is found to depend on the D silicone unit chain length of starting PDMS carbinol. While, PDMS based SPUR (component (A)) made from PDMS carbinol with lower D silicone unit chain length (˜5) is found to be compatible, as was evidenced from clear appearance of the blend, the blend appeared hazy when PDMS based SPUR (component (A)) made from PDMS carbinol with high D silicone unit chain lengths (>12) indicating the incompatibility of these materials with SPUR (component (B)) made from high Mw propylene glycols, irrespective of the ratio of mixing (5 to 20 wt %). While most of the mechanical properties of SPUR (component (B)) made from high Mw polypropylene glycol remained the same or slightly improved with the addition of PDMS based SPUR (component (A)) made from PDMS carbinols with higher D silicone unit chain length, relatively a significant improvement of all mechanical properties is evident with the addition of PDMS based SPUR (component (A)) made from PDMS carbinols with lower D silicone unit chain length. In the latter case, the magnitude of improvement is found to be dependent on the amount of PDMS based SPUR (component (A)) in the blend.

TABLE 6
The percents in the below tables 6 and 7 are weight percent based on total
weight of the blend of (A) and (B) including the weight of the catalyst

| | | Resin 1050 + | Resin 1050 + | Resin 1050 + | Resin 1050 + | Resin 1050 + | Resin 1050 + |
|---|---|---|---|---|---|---|---|
| | | 5% | 10% | 20% | 5% | 10% | 20% |
| | | SPUR | SPUR | SPUR | SPUR | SPUR | SPUR |
| | Resin 1050 | PDMS 1 | PDMS 1 | PDMS 1 | PDMS 2 | PDMS 2 | PDMS 2 |
| Fmax | 0.57 | 0.64 | 0.89 | 1.1 | 0.7 | 0.71 | 0.73 |
| F at rupture | 0.57 | 0.64 | 0.88 | 1.1 | 0.7 | 0.71 | 0.72 |
| Elongation | 100 | 111 | 143 | 138 | 132 | 119 | 107 |
| Mod50 | 0.38 | 0.4 | 0.45 | 0.51 | 0.39 | 0.42 | 0.45 |
| Mod100 | 0.57 | 0.61 | 0.69 | 0.82 | 0.59 | 0.54 | 0.7 |
| Shore A | 32.9 | 35.3 | 35.7 | 38.3 | 35.5 | 34.1 | 35.1 |
| Aspect | transparent | transparent | transparent | transparent | Slightly hazy | Hazy | Hazy |

TABLE 7

| | Resin 1050 + | Resin 1050 + | Resin 1050 + | Resin 1050 + | Resin 1050 + | Resin 1050 + |
|---|---|---|---|---|---|---|
| | 5% SPUR | 10% SPUR | 20% SPUR | 5% SPUR | 10% SPUR | 20% SPUR |
| | PDMS 3 | PDMS 3 | PDMS 3 | PDMS 4 | PDMS 4 | PDMS 4 |
| Fmax | 0.77 | 0.83 | 0.81 | 0.75 | 0.78 | 0.79 |
| F at rupture | 0.77 | 0.82 | 0.8 | 0.75 | 0.78 | 0.79 |
| Elongation | 144 | 138 | 132 | 138 | 150 | 140 |
| Mod50 | 0.41 | 0.43 | 0.41 | 0.41 | 0.39 | 0.4 |
| Mod100 | 0.61 | 0.66 | 0.66 | 0.62 | 0.6 | 0.62 |
| Shore A | 35.1 | 33.1 | 34.1 | 29.7 | 30.5 | 28.3 |
| Aspect | Hazy | Hazy | Hazy | Hazy | Hazy | Hazy |

The procedures used to determine the mechanical properties in Tables 4-7 are those described in the corresponding ISO standard: rubber, vulcanized or thermoplastic—determination of tensile stress-strain properties (ISO 37) and ISO standard: Plastics and ebonite—Determination of indentation hardness by means of a Durometer (Shore hardness) (ISO 868).

The SPUR PDMS 1 (PDMS carbinol D silicone unit chain length is 5) was found to be compatible with SPUR 1050 (Commercial grade from Momentive Performance materials) SPUR made from high molecular weight polypropylene glycol with isophorone diisocyanate available from Bayer (as Desmodurl); Also, there was an increase of the mechanicals properties proportional to the increase of the concentration of the mixture in this case.

The heat ageing characteristics of these blends were also investigated; see in this regard Table 8 below. The heat ageing characteristics of these blends, in comparison to neat SPUR (component (B)) made from high Mw polypropylene glycol, was inferred by measuring the mechanical properties, before and after heating the cured sheets at 120 deg C. for 24 h in a hot-air oven. While, a drastic reduction of mechanical properties was evident in the case of neat SPUR (component (B)) made from high Mw polypropylene glycol, these mechanical properties are less severely affected in the case of the blends containing 80 wt % of SPUR made from high Mw polypropylene glycol (component (B)) and 20 wt % of PDMS based SPUR (component (A)) made from PDMS carbinols with lower D silicone unit chain length (˜5). In fact, the mechanical properties of the noted above blend (i.e., 20%/80%; AIB weight percent based on total weight of the blend—(1000 ppm catalyst DBTDL was added to the blend of A and B) observed after the heat ageing were mostly similar to those of the as-prepared SPUR (component (B)) made from high Mw polypropylene glycol. These results clearly indicate that the addition of PDMS based SPUR made from PDMS carbinols (component (A)) with lower D silicone unit chain length improves the heat ageing characteristics of SPUR (component (B)) made from high Mw polypropylene glycol. Interestingly, however, the addition of PDMS based SPUR (component (A)) made from PDMS carbinols with higher D silicone unit chain lengths (>12) does not improve the heat ageing characteristics of SPUR (component (B)) made from high Mw polypropylene glycol to any significant extent.

TABLE 8

| | | | | |
|---|---|---|---|---|
| | Resin 1050 + | Resin 1050 + | Resin 1050 + | Resin 1050 + |
| | 20% SPUR | 20% SPUR | 20% SPUR | 20% SPUR |
| Resin 1050 | PDMS 1 | PDMS 2 | PDMS 3 | PDMS 4 |

Initial value

| | | | | | |
|---|---|---|---|---|---|
| Fmax | 0.57 | 1.1 | 0.73 | 0.81 | 0.79 |
| F at rupture | 0.57 | 1.1 | 0.72 | 0.8 | 0.79 |
| Elongation | 100 | 138 | 107 | 132 | 140 |
| Mod50 | 0.38 | 0.51 | 0.45 | 0.41 | 0.4 |
| Mod100 | 0.57 | 0.82 | 0.7 | 0.66 | 0.62 |
| Shore A | 32.9 | 38.3 | 35.1 | 34.1 | 28.3 |

After aging 24 hours at 120° C.

| | | | | | |
|---|---|---|---|---|---|
| Fmax | 0.23 | 0.6 | 0.31 | 0.36 | 0.2 |
| F at rupture | 0.22 | 0.59 | 0.28 | 0.34 | 0.2 |
| Elongation | 126 | 111 | 111 | 155 | 146 |
| Mod50 | 0.11 | 0.29 | 0.16 | 0.12 | 0.07 |
| Mod100 | 0.19 | 0.54 | 0.29 | 0.222 | 0.13 |
| Shore A | 9.9 | 25.9 | 14.7 | 12.1 | 7.7 |

In order to infer the release characteristics of the above blends of PDMS based SPUR made from PDMS carbinols (component (A)) with different D silicone unit chain lengths and SPUR (component (B)) made from high Mw polypropylene glycol, a tape adhesion test with Tesa 4154 (the test with Tesa 4154, which can be bought at Tesa SA, is a qualitative test method) was done on 200 micron thick films of the blends (having a 5:95 A:B wt ratio of weight percents of A and B based on the total weight of A and B, along with moisture cure catalyst (DBTDL)) made on a glass substrate; [Catalyst weight was not included. 1000 ppm (0.1%) DBTDL catalyst was added to the blend of A and B] As observed in Table 9 below with thick (˜3 mm) sheets, the blend of components (A) and (B) made with PDMS based SPUR made from PDMS carbinols (component (A)) with lower D silicone unit chain length (˜5) appeared clear, while the coating made with other blends were found to be hazy. Interestingly, the release characteristics of all coatings, irrespective of the D silicone unit chain length of starting PDMS carbinol, was found to be the same and was similar to that observed with neat PDMS based SPUR made from PDMS carbinols (100%). These results suggest the preferential surface migration of SPUR made from PDMS (component (A)) during the moisture curing of the coating, thereby rendering the surface more hydrophobic, similar to that of neat PDMS based SPUR. These results are significant, as they demonstrate a potential means to obtain a “water-repellant” SPUR composition based on high Mw polypropylene glycol. Also, the blends can be considered “cost-effective” coating composition, in comparison to 100% SPUR made from PDMS.

TABLE 9

| | D-chain length | | |
|---|---|---|---|
| | of PDMS | | Release |
| Composition | carbinol | Appearance | effect |
| SPUR-1050 + PDMS | 5 | Clear | Same as PDMS |
| SPUR-1 (95:5) | | | SPUR-1 |
| SPUR-1050 + PDMS | 12 | Hazy | Same as PDMS |
| SPUR-2 (95:5) | | | SPUR-2 |
| SPUR-1050 + PDMS | 18 | Hazy | Same as PDMS |
| SPUR-3 (95:5) | | | SPUR-3 |
| SPUR-1050 + PDMS | 25 | Hazy | Same as PDMS |
| SPUR-4 (95:5) | | | SPUR-4 |

### Typical Procedure of Making of Blending of SPUR 1050 and PDMS SPUR

Each of the different ratios of mixtures of SPUR 1050 and PDMS SPUR in Table 7 above, were blended in a Hauschild speed mixer for a period of 2 min. The resulting blend was poured into a Teflon mould which was 3 mm thick and leveled with the aid of a PVC bar. The mould containing the blend was kept in a climatic chamber at 37° C. and 95% of humidity for a period of 3 days and subsequently in an oven at 50° C. for a period of 4 days. A minimum of 2 h at 23° C. and 50% of moisture were allowed before the physical evaluation. All mechanical property evaluations were done under ambient conditions and in accordance with the procedure described in the corresponding ISO standard: rubber, vulcanized or thermoplastic—determination of tensile stress-strain properties (ISO 37) and ISO standard: Plastics and ebonite—Determination of indentation hardness by means of a Durometer (Shore hardness) (ISO 868).

While the invention has been described with reference to a preferred embodiment, those skilled in the art will understand that various changes may be made and equivalents may be substituted for elements thereof without departing from the scope of the invention. It is intended that the invention not be limited to the particular embodiment disclosed as the best mode for carrying out this invention, but that the invention will include all embodiments falling within the scope of the appended claims. All citations referred herein are expressly incorporated herein by reference.

What is claimed is:

1. A composition comprising: (A) at least one silylated polyurethane resin containing polydiorganosiloxane; and, (B) at least one silylated polyurethane resin.

2. The composition of claim 1 wherein the polydiorganosiloxane moiety of at least one silylated polyurethane resin containing polydiorganosiloxane (A) is polydimethylsiloxane.

3. The composition of claim 1 wherein silylated polyurethane resin containing polydiorganosiloxane (A) is made by the process comprising reacting a hydroxyl- or isocyanate-terminated polyurethane prepolymer based on polydiorganosiloxane with a isocyanato silane, or an active hydrogen-containing silane, respectively.

4. The composition of claim 1 wherein silylated polyurethane resin containing polydiorganosiloxane (A) is made by the process comprising reacting a hydroxyl- or isocyanate-terminated polyurethane prepolymer based on polydiorganosiloxane with a isocyanato silane, or an active hydrogen terminated silane, respectively, wherein the polydiorganosiloxane moiety of the hydroxyl- or isocyanate-terminated polyurethane prepolymer based on polydiorganosiloxane contains up to about 25 diorganosiloxy units.

5. The composition of claim 4 wherein the polydiorganosiloxane moiety of the hydroxyl- or isocyanate-terminated polyurethane prepolymer based on polydiorganosiloxane contains up to about 12 diorganosiloxy units.

6. The composition of claim 4 wherein the polydiorganosiloxane moiety of the hydroxyl- or isocyanate-terminated polyurethane prepolymer based on polydiorganosiloxane contains about 5 diorganosiloxy units.

7. The composition of claim 1 wherein component (B) has a viscosity of up to about 3000 cP.

8. The composition of claim 1 wherein the silylated polyurethane resin (B) is made from polyol having a molecular weight of from about 500 to about 25,000.

9. The composition of claim 1 wherein the silylated polyurethane resin (B) is made from polypropylene glycols having a molecular weight of from about 2,000 to about 16,000.

10. The composition of claim 1 wherein the composition is moisture curable.

11. The composition of claim 1 wherein the composition is capable of condensation cure.

12. The composition of claim 1 wherein components (A) and/or (B) are in the absence of urea moieties.

13. The composition of claim 1 wherein silylated polyurethane resin containing polydiorganosiloxane (A) is present in an amount of from about 5 weight percent to about 30 weight percent; and, silylated polyurethane resin (B) is present in an amount of from about 70 weight percent to about 95 weight percent, said weight percent being based on the total weight of components (A) and (B).

14. The composition of claim 1 wherein silylated polyurethane resin containing polydiorganosiloxane (A) is present in an amount of from about 5 weight percent to about 25 weight percent; and, silylated polyurethane resin (B) is present in an amount of from about 75 weight percent to about 95 weight percent, said weight percent being based on the total weight of components (A) and (B).

15. The composition of claim 1 wherein silylated polyurethane resin containing polydiorganosiloxane (A) is present in an amount of from about 5 weight percent to about 20 weight percent; and, silylated polyurethane resin (B) is present in an amount of from about 80 weight percent to about 95 weight percent, said weight percent being based on the total weight of components (A) and (B).

16. A release coating comprising the composition of claim 1.

17. A process of treating a substrate comprising:
coating a substrate with a composition comprising: (A) at least one silylated polyurethane resin containing polydiorganosiloxane; and, (B) at least one silylated polyurethane resin; and,
curing the coated substrate.

18. The substrate made by the process of claim 15.

19. The composition of claim 1 which has an improved property of at least one of tensile strength, modulus, elongation at break, Shore-A hardness and water repellency as compared to an equivalent substrate which is coated with a composition in the absence of component (A).

20. A sealant composition comprising the composition of claim 1.

21. A process of making a release coating comprising combining the components of claim 1.
